(19) United States
(12) Patent Application Publication
(10) Pub. No.: US 2012/0227033 A1
(43) Pub. Date: Sep. 6, 2012

(54) METHOD AND APPARATUS FOR EVALUATING SOFTWARE PERFORMANCE

(76) Inventor: LEI YU, Austin, TX (US)

(21) Appl. No.: 13/038,554

(22) Filed: Mar. 2, 2011

(51) Int. Cl. G06F 9/44

(52) U.S. Cl. 717/124

(57) ABSTRACT

A method and apparatus are provided for evaluating called routines in a computer program. The method comprises periodically interrupting execution of a computer program. One or more entries in a call stack is then inspected to identify one or more possible call operations. The one or more possible call operations is then validated as an actual call entry based on the possible call entry being associated with a code segment in a program module. Data regarding each validated call entry identified during each of the periodic interrupts is collected and may be presented to a computer user.

### BACKGROUND

1. Field of the Invention

Embodiments of this invention relate generally to computers, and, more particularly, to a method and apparatus for identifying potential bottlenecks in a computer program.

2. Description of Related Art

A typical computer program is a list of instructions, which when compiled or assembled, generates a sequence of machine instructions or operations that a processor executes. Commonly, the computer program is organized into a plurality of routines that are each designed to perform a particular function. Consequently, each time the computer program desires to perform the particular function, the corresponding routine may be called and executed. Each of these routines may be called throughout the computer program and may be used numerous times over a preselected period of time, depending on the current operation of the computer program.

The organization and flow of the computer program, and thus the performance of the computer program, will greatly depend upon how often each of these routines is called. That is, if a particular routine is called and executed too often, it can create a hotspot or bottleneck in the computer program, undesirably reducing the performance of the computer program. The operation of the computer program could be greatly enhanced by revising the program to alleviate such bottleneck situations. Revisions to a computer program to alleviate a bottleneck situation may be straightforward once the bottleneck has been identified, however, the size and complexity of many computer programs makes it difficult to predict or anticipate how often each of these routines may be called and executed. Moreover, the bottleneck may only occur during certain types of operation that may not regularly or predictably occur, as they may result only when a large number of variables coincide. Thus, it is difficult for a computer programmer or performance analysts to identify a bottleneck situation.

There are a variety of tools that performance analysts have used to help identify such bottlenecks. For example, Intel VTune, GProf, PIN, Valgrind, and Oprofile are available for analyzing the performance of a computer program. However, each of these tools has shortcomings that reduce their effectivness.

Intel VTune, PIN and Valgrind use a binary instrumentation technique to collect and graph information. There are several major drawbacks to the instrumentation approach, such as overhead, memory consumption, and compatibility with the computer program being evaluated. Normally, the instrumentation approach adds an extra prolog and epilog log at the beginning and end of a function to keep track of program execution. These extra logs add significantly to the overhead of the computer program. In fact, in some instances the extra logs introduced as part of the analysis add about 2 to 10 times more overhead than the original program. Additionally, the instrumentation consumes much more memory than what the original program needs. The approach could fail simply due to resource limitations. Finally, the instrumentation approach is incompatible with some of the computer programs being evaluated, particularly where the computer program is already executing.

GPROF is a call graph profile tool from the GNU gcc compiler tool kit, but it has significant limitations that substantially reduce its usefulness in analyzing the performance of a computer program. For example, GPROF requires users to recompile their software program with a “-pg” flag. Recompiling the computer program to be evaluated is inconvenient at best and may be extremely difficult in some instances, as some of the program (such as binaries) may be pre-built and provided by third parties. Additionally, GPROF may also suffer from overhead problems.

Oprofile is an open source performance analysis tool that can be used for performance analysis. It uses the function stack frame pointer in the binaries to collect an execution call path. However, to build up the function stack frame pointer, Oprofile requires that the source code of the computer program be compiled with a “-fno-omit-fram-pointer” option. As discussed above with respect to GPROF, recompiling the computer program is undesirable. Moreover, using the “-fno-omit-fram-pointer” option conflicts with optimization options.

### SUMMARY OF EMBODIMENTS OF THE INVENTION

In one aspect of the present invention, a method is provided for evaluating called routines in a computer program. The method comprises periodically interrupting execution of a computer program. One or more entries in a call stack is then inspected to identify one or more possible call operations. The one or more possible call operations is then validated as an actual call entry based on the possible call entry being associated with a code segment in a program module. Data regarding each validated call entry identified during each of the periodic interrupts is collected.

In another aspect of the present invention, a computer readable storage device encoded with at least one instruction that, when executed by a computer, performs a method for evaluating called routines in the computer program is provided. The method comprises periodically interrupting execution of the computer program. One or more entries in a call stack is then inspected to identify one or more possible call operations based on the possible call entry being associated with a code segment in a program module. The one or more possible call operations is then validated as an actual call entry. Data regarding each validated call entry identified during each of the periodic interrupts is collected.

In another aspect of the present invention, an apparatus for evaluating called routines in a computer program is provided. The apparatus comprises a processing device having a call stack and being adapted to execute the computer program and periodically interrupt execution of the computer program. The processing device is adapted to operate during the periodic interrupt to inspect one or more entries in the call stack to identify one or more possible call operations, to validate each of the one or more possible call operations as an actual call entry based on the possible call entry being associated with a code segment in a program module, and to collect data regarding each validated call entry.

### BRIEF DESCRIPTION OF THE DRAWINGS

The invention may be understood by reference to the following description taken in conjunction with the accompanying drawings, in which the leftmost significant digit(s) in the reference numerals denote(s) the first figure in which the respective reference numerals appear, and in which:

FIG. 1 schematically illustrates a simplified block diagram of a computer system including a graphics card that employs a storage scheme according to one embodiment;

FIG. 2 illustrates an exemplary representation of one embodiment of a call stack that may be used in the computer system of FIG. 1 according to one embodiment;

FIG. 3 illustrates a flowchart representation of a process for unwinding the stack of FIG. 2 according to one embodiment of the present invention.

FIG. 4 stylisically illustrates one organization of virtual memory in the computer system of FIG. 1;

FIG. 5 illustrates a flowchart representation of a process for filtering results obtained from unwinding the stack of FIG. 2 according to one embodiment of the present invention;

FIG. 6 illustrates a flowchart representation of a process for filtering results obtained from unwinding the stack of FIG. 2 according to another embodiment of the present invention;

FIG. 7 illustrates a flowchart representation of a process for filtering results obtained from unwinding the stack of FIG. 2 according to another embodiment of the present invention; and

FIG. 8 illustrates a visual presentation of data associated with routines called during operation of a computer program.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but, on the contrary, the intention is to cover all modifications, equivalents, and alternatives falling within the spirit and scope of the invention as defined by the appended claims.

### DETAILED DESCRIPTION

Illustrative embodiments of the invention are described below. In the interest of clarity, not all features of an actual implementation are described in this specification. It will of course be appreciated that in the development of any such actual embodiment, numerous implementation-specific decisions may be made to achieve the developers' specific goals, such as compliance with system-related and business-related constraints, which may vary from one implementation to another. Moreover, it will be appreciated that such a development effort might be complex and time-consuming, but may nevertheless be a routine undertaking for those of ordinary skill in the art having the benefit of this disclosure.

The present invention will now be described with reference to the attached figures. Various structures, connections, systems and devices are schematically depicted in the drawings for purposes of explanation only and so as to not obscure the disclosed subject matter with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

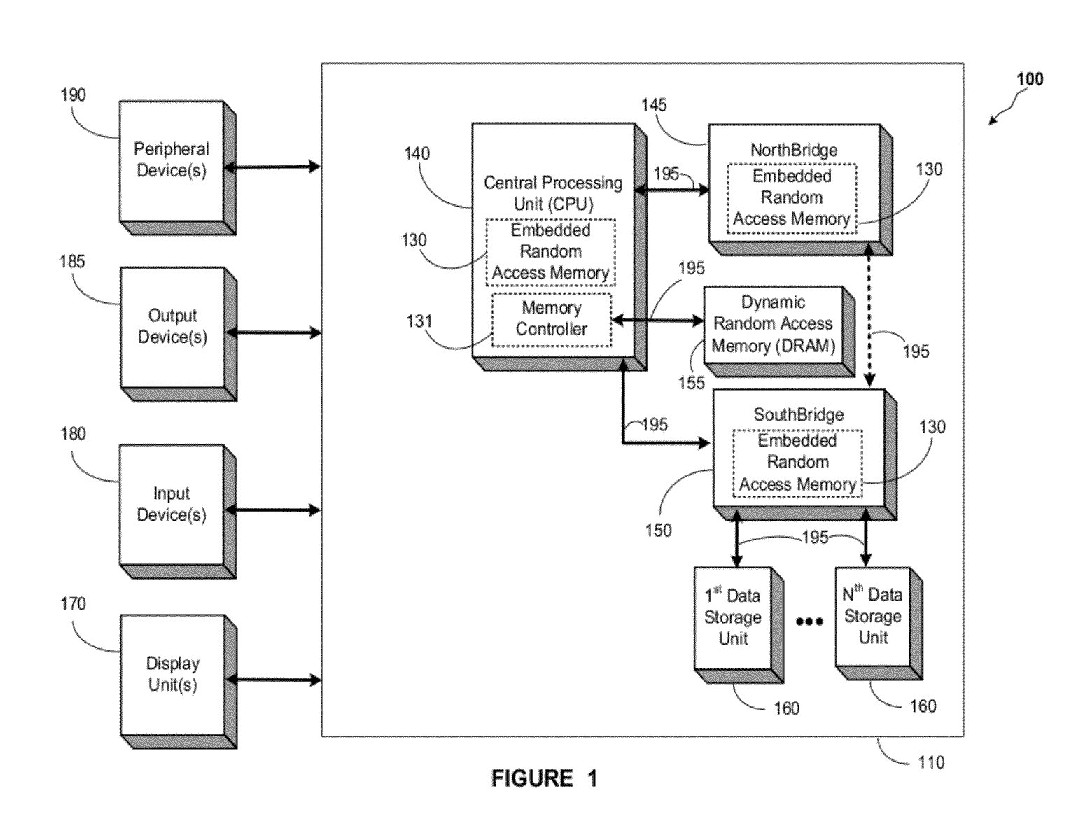

Turning now to FIG. 1, a block diagram of an exemplary computer system 100, in accordance with an embodiment of the present invention, is illustrated. In various embodiments, the computer system 100 may be a personal computer, a laptop computer, a handheld computer, a netbook computer, a mobile device, a telephone, a personal data assistant (PDA), a server, a mainframe, a work terminal, or the like. The computer system includes a main structure 110 which may be a computer motherboard, circuit board or printed circuit board, a desktop computer enclosure and/or tower, a laptop computer base, a server enclosure, part of a mobile device, personal data assistant (PDA), or the like.

In one embodiment, the computer system 100 includes a central processing unit (CPU) 140, which is connected to a northbridge 145. The CPU 140 and northbridge 145 may be housed on the motherboard (not shown) or some other structure of the computer system 100. Alternative embodiments that alter the arrangement of various components illustrated as forming part of main structure 110 are also contemplated. The CPU 140 and/or the northbridge 145, in certain embodiments, may each include an embedded memory 130 in addition to other embedded memories 130 found elsewhere in the computer system 100. In certain embodiments, the CPU 140 may include a memory controller 141 that may be coupled to a external system RAM (or DRAM) 155; in other embodiments, the system RAM 155 may be coupled to the northbridge 145. The system RAM 155 may be of any RAM type known in the art; the type of RAM 155 does not limit the embodiments of the present invention.

In one embodiment, the northbridge 145 may be connected to a southbridge 150. In other embodiments, the northbridge 145 and southbridge 150 may be on the same chip in the computer system 100, or the northbridge 145 and southbridge 150 may be on different chips. In one embodiment, the southbridge 150 may have an embedded memory 130, in addition to any other embedded memories 130 elsewhere in the computer system 100. In various embodiments, the southbridge 150 may be connected to one or more data storage units 160. The data storage units 160 may be hard drives, solid state drives, magnetic tape, or any other writable media used for storing data. In various embodiments, the central processing unit 140, northbridge 145, southbridge 150, DRAM 155 and/or embedded RAM 130 may be a computer chip or a silicon-based computer chip, or may be part of a computer chip or a silicon-based computer chip. In one or more embodiments, the various components of the computer system 100 may be operatively, electrically and/or physically connected or linked with a bus 195 or more than one bus 195.

In different embodiments, the computer system 100 may be connected to one or more display units 170, input devices 180, output devices 185 and/or other peripheral devices 190. It is contemplated that in various embodiments, these elements may be internal or external to the computer system 100, and may be wired or wirelessly connected, without affecting the scope of the embodiments of the present invention.

Commonly, computer programs are loaded into the RAM 155, the embedded RAM 130, the data storage units 160 and/or various ones of the peripheral devices 190 from which they may be retrieved and executed by the CPU 140. Exemplary programs that may be stored and executed by the computer 100 include operating systems, such as Linux, application programs, and the like.

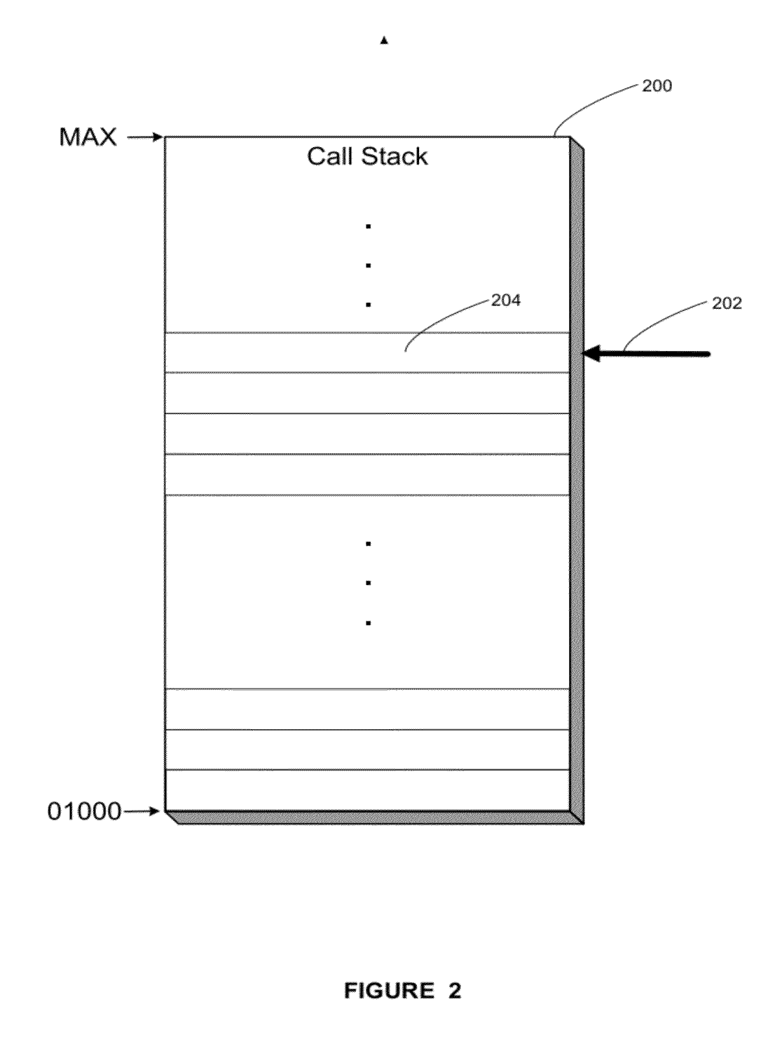

Turning now to FIG. 2, a diagram of an exemplary implementation of a stack 200 that may be used in the computer system 100. In the illustrated embodiment, the stack 200 is an area of memory with a fixed origin and a variable size. Initially the size of the stack is zero. A stack pointer 202, usually in the form of a hardware register (not shown), points to the most recently referenced location 204 on the stack 200.

There are at least two operations of the stack 200 that are relevant here—push and pop. A push operation involves a data item being placed at the location pointed to by the stack pointer 202, and the address in the stack pointer 202 is adjusted by the size of the data item. A pop or pull operation involves a data item at the current location pointed to by the stack pointer 202 being removed, and the stack pointer 202 is adjusted by the size of the data item.

There are many variations on the basic principle of stack operations. However, in the illustrated embodiment, the stack 200 has a fixed location in memory at which it begins, and as data items are added to the stack, the stack pointer is displaced to indicate the current extent of the stack, which expands away from the origin.

It is envisioned that the stack pointer 202 may point to the origin of the stack 200 or to a limited range of addresses either above or below the origin (depending on the direction in which the stack grows); however, the stack pointer 202 is not permitted to cross the origin of the stack 200. In other words, if the origin of the stack 200 is at address 1000 and the stack 200 grows downwards (towards addresses 999, 998, and so on), the stack pointer 202 should not be incremented beyond 1000 (to 1001, 1002, etc.). If a pop operation on the stack 200 causes the stack pointer 202 to move past the origin of the stack, a stack underflow occurs. If a push operation causes the stack pointer 202 to increment or decrement beyond the maximum extent of the stack 200, a stack overflow occurs.

Those skilled in the art will appreciate that during the operation of the computer system 100, the stack 200 may be used as a call stack 200 to hold information about procedure/function calling and nesting in order to switch to the context of the called function and restore to the caller function when the calling finishes. These calls follow a runtime protocol between caller and callee to save arguments and a return value on the stack 200. Generally, the call stack 200 is used implicitly by the operating systems to support CALL and RETURN statements (or their equivalents) and is not manipulated directly by the programmer

The call stack 200, therefore, contains information that may be used to evaluate when and how often each routine is called. By periodically interrupting the operation of the computer system 100 and unwinding the call stack 200, information regarding each call can be collected and used to analyze the performance of the computer program operating thereon.

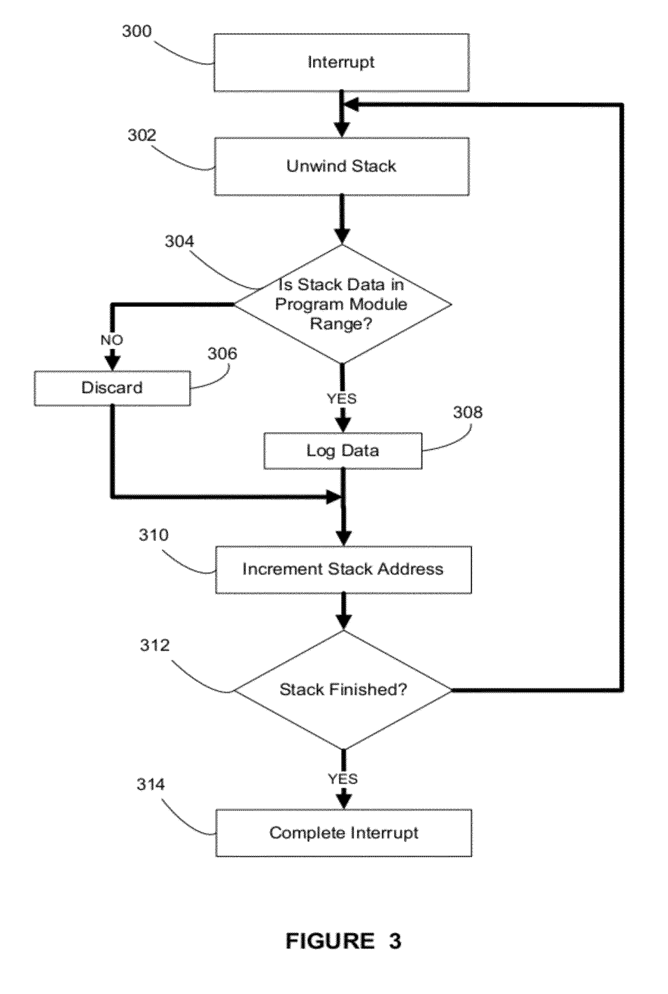

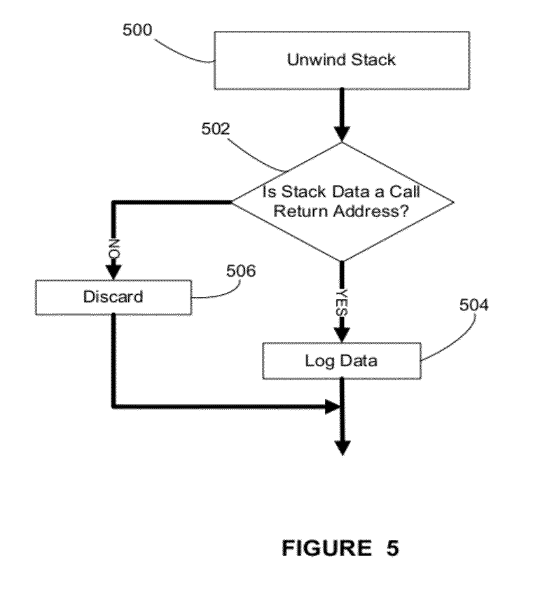

Turning now to FIG. 3, a flowchart representation of one process that may be utilized to collect information from the call stack 200 is shown. Those skilled in the art will appreciate that the computer program(s) being evaluated is allowed to operate on the computer system 100. During the operation of the evaluated program, the computer system 100 is interrupted at block 300. At block 302, while the computer system 100 is interrupted, the content of a first location in the stack 200 is retrieved for analysis to determine if it represents a call executed to a particular routine. At block 304, a determination is made as to whether the data retrieved from the stack has an address that falls within a range associated with a program module. If not, the retrieved stack data is discarded at block 306. On the other hand, if the retrieved stack data does fall within a range associated with a program module, then the data is initially assumed to be a call and it is logged for further analysis, as discussed below in conjunction with FIG. 5.

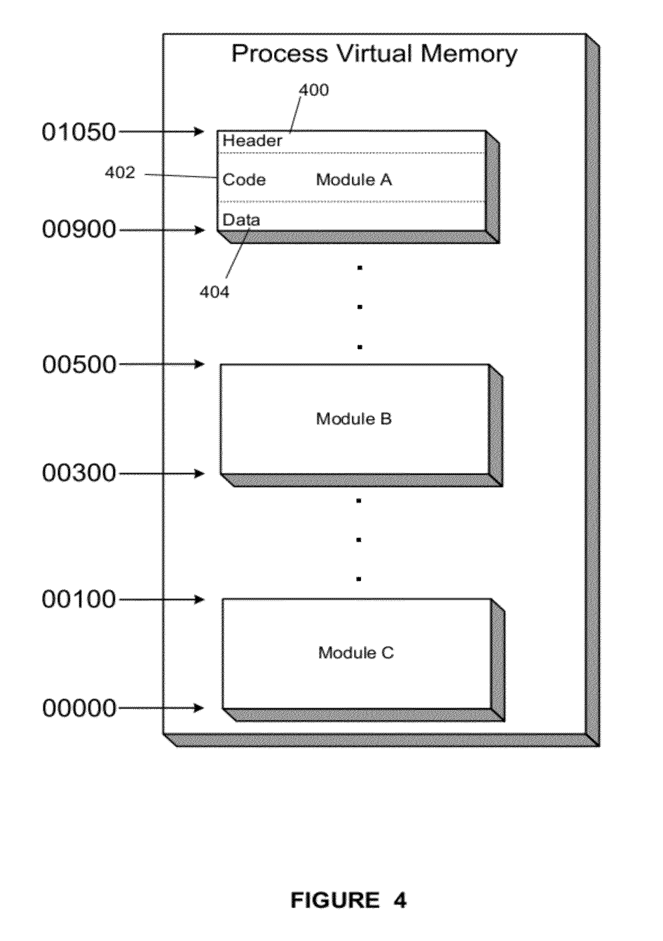

Turning briefly to FIG. 4, a representative virtual memory structure for the computer system 100 is shown. For purposes of illustration, three separate program modules (A,B, and C) that are currently operating on the computer system 100 are shown at different locations within virtual memory. Those skilled in the art will appreciate that when each of the Modules A, B and C are loaded by the computer system 100, the operating system software assigns them to their own unique location in memory, each having an address that does not overlap with any other program module currently operating on the computer system. Thus, to make the determination identified in block 304, the address range for each of the modules is compared to the address information contained within the data retrieved from the stack. If the address in the stack data does not fall within one of the assigned ranges for Modules A, B or C, then the stack data cannot correspond to a call within one of these modules. If the address in the stack data does fall within one of the assigned ranges for Modules A, B or C, then it remains possible that the retrieved stack data does represent a call, but further analysis is required.

Once the retrieved stack data is either discarded or logged, control transfers to block 310 where the stack address is incremented to point to the next stack data to be retrieved for analysis. At block 312, a determination is made as to whether any additional stack data remains to be retrieved. That is, if the incremented stack address now points outside the stack, then all of the stack data has been retrieved and analyzed using this first analysis, and control passes to the flowchart representation shown in FIG. 5 for further analysis of the logged stack data. If, on the other hand, additional stack data remains to be analyzed, then control transfers back to block 302 where the process is repeated until all of the stack data has been analyzed.

Turning now to FIG. 5, the logged stack data is validated or discarded beginning at block 500 based upon information obtained from the next address in the stack. Those skilled in the art will appreciate that the call return address should be the next instruction after a call instruction. The call return address will be the call instruction address plus the length of the call instruction. Thus, at block 502, if a determination is made that this subsequently retrieved stack data is the instruction address after a call instruction, then the logged data is a valid call data and will be kept as a node of call edge and logged in block 504.

Otherwise, if the subsequently retrieved stack data is not the instruction address after a call instruction, then the logged data is not a valid call data and will be filtered or discarded at block 506.

After the processes described in FIGS. 3 and 5 complete, then the interrupt is ended and the computer system 100 again begins to execute the computer program being evaluated. After a period of time, the computer system is again interrupted and the processes described in FIGS. 3 and 5 are again performed to identify additional calls. This process repeats numerous times over a desired period of evaluation, collecting more and more information regarding the calls. At the completion of the evaluation period, the logged data may be presented to the analyst in any of a variety of formats, so that bottlenecks associated with the calls may be identified. It is envisioned that the data may be presented in list form, graphical form or other form suitable for summarizing the results of the analysis.

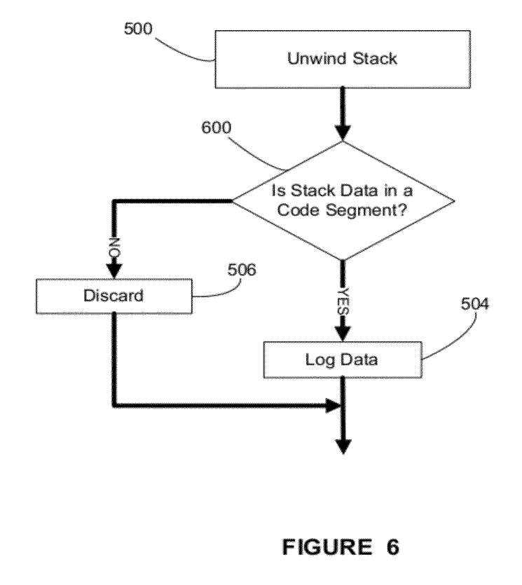

Turning now to FIG. 6, an alternative embodiment of the instant invention is shown. In particular, the instant embodiment shown in FIG. 6 differs from the embodiment shown in FIG. 5 with respect to the methodology used to determine if the logged stack data should be validated or discarded. In the embodiment shown in FIG. 6, the process differs beginning at block 600 where a determination is made as to whether the data retrieved from the stack has an address that falls within a range associated with a data segment or a code segment. That is, each of the modules A, B, and C shown in FIG. 4 are comprised of at least three sections: a header 400, a code segment 402 and a data segment 404. If the stack data has an address that falls within a data segment 404, then control transfers to block 506 where the stack data is discarded. On the other hand, if the stack data has an address that falls within a range associated with a code segment, then the data is assumed to be a call and is logged for further analysis. Ordinarily, a call may be made to another line of code, not to data. Thus, if it is determined that the call is being made to a portion of a module that contains data, then it may be assumed that the stack data is not a call, but if the call is being made to a portion of a module that contains code, then it may be assumed that the stack data is a call.

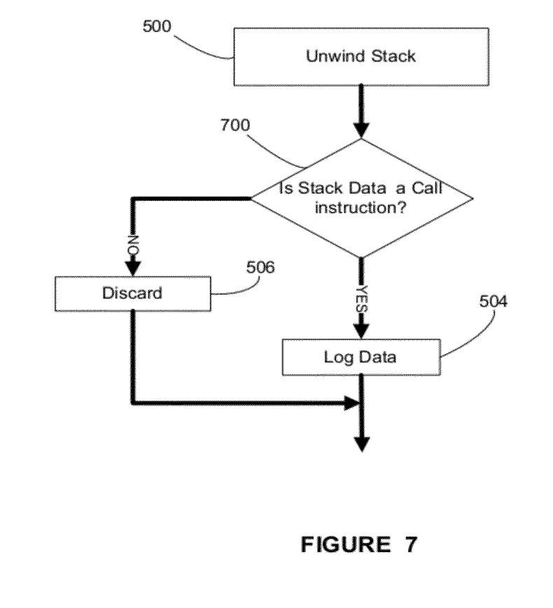

Turning now to FIG. 7, an alternative embodiment of the instant invention is shown. In particular, the instant embodiment shown in FIG. 7 differs from the embodiments shown in FIGS. 5 and 6 with respect to the methodology used to determine if the logged stack data should be validated or discarded. In the embodiment shown in FIG. 7, the process differs beginning at block 700 where a determination is made as to whether the data retrieved from the stack is a call instruction. For example, the stack data may be inspected to determine if it is in the format of a call instruction and includes a call op code. At block 700, the stack data may be compared to a list of known op codes (see Table I, below) to determine if a match exists. Once a particular op code is identified, then additional parameters associated with the particular op code may also be inspected to determine if the stack data is, in fact, a call instruction. For example, each op code has a known instruction length between two and seven bytes long (see Table I, below). Thus, the stack data may be inspected to determine if the length of the suspected call instruction corresponds to the known length of a call instruction having the identified op code. If either the op code does not correspond to a known call instruction or the length of the suspected instruction is incorrect, then control transfers to block 506 where the stack data is discarded. On the other hand, if the stack data has an appropriate op code and the length of the instruction corresponds, then the data is assumed to be a call and is logged for further analysis.

TABLE I

| Name | OpCode |
|---|---|
| Call fword ptr [rbx] | FF 1B |
| Call dword ptr [ebp+18h] | FF 55 18 |
| Call qword ptr [rsp+48h] | FF 54 24 48 |
| Call qword ptr [rax+ 000000A0h] | FF 90 A0 00 00 00 |
| Call 7DE1:0A257DDC | 9A DC 7D 25 0A E1 7D |

Those skilled in the art will appreciate that the methodologies described in FIGS. 5-7 may be employed individually or in various combinations to perform singular or multi-step tests to identify whether the stack data is a call instruction that should be logged.

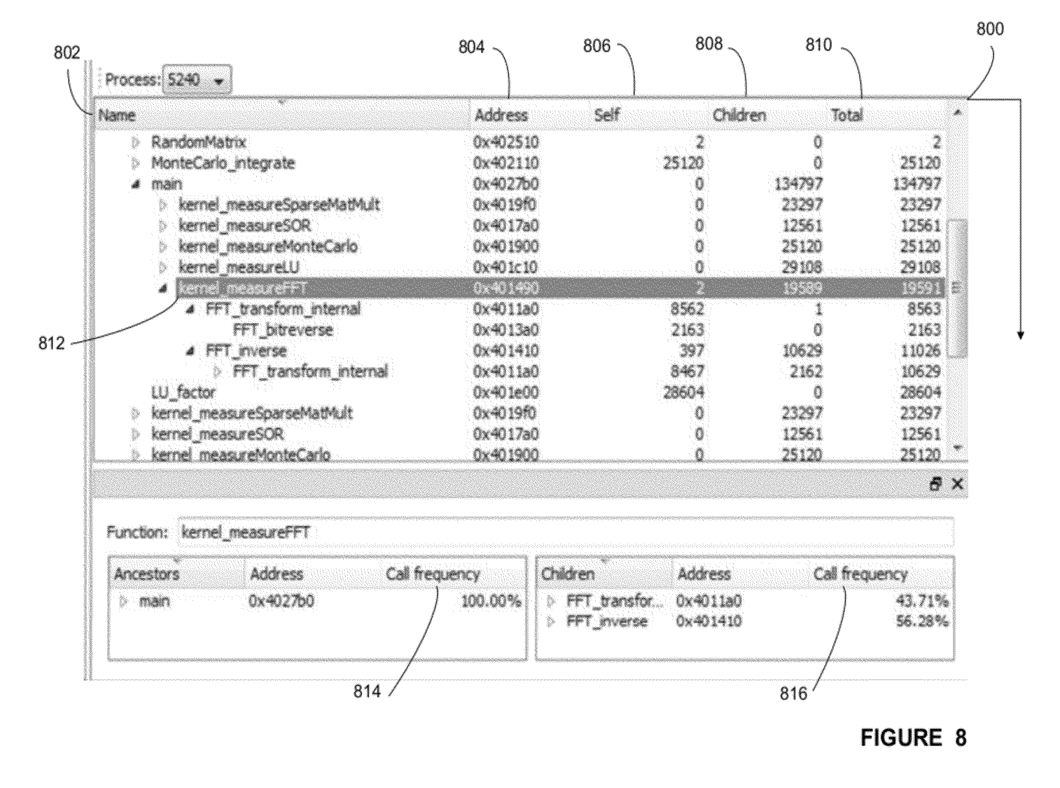

Turning now to FIG. 8, an exemplary visual presentation 800 of data retrieved during the forgoing processes is shown. Those skilled in the art will appreciate that the visual presentation 800 may take the form of an electronic display, a printed display, an audio display or the like. In the illustrated embodiment, a portion of the plurality of routines or functions called by the computer program being evaluated are identified in a Name section 802 of the visual display 800. In the instant embodiment, the Name section 802 is organized to illustrate parent and children routines. For example, the parent routine kernel_measureFFT is shown to have two children, FFT_transform_internal and FFT_inverse. Each of the parent and child routines identified in the Name section 802 also have an associated Address section 804 that identifies the beginning address in memory where each routine is located. Further, each routine also has a Self section 806, which identifies the amount of time spent actually performing the identified routine or function. The Children section 808 identifies the amount of time spent actually performing each of the children routines or functions. The Total section 810 contains information regarding the total time spent executing both the routine itself and its children.

Additional information or data can be obtained by selecting any of the routines, such as Kernel_measureFFT shown by the highlighted line 812, which causes additional information regarding the selected routine to appear below in Call Frequency sections 814, 816. Call Frequency section 814 includes information regarding the ancestor routines of the selected routine, which in the illustrated embodiment, includes the main routine. The call frequency of this ancestor routine is displayed as a percentage, which in the exemplary display is 100%. The 100% call frequency indicates that the Kernel_measureFFT routine is called every time that the main routine is called, and thus, that the remaining children of the main routine (e.g., kernel_measureSparseMatMult, Kernel_measureSOR, kernel_measureMonteCarlo, and kernel_measureLU) are not called at all. Likewise the call frequency of the children routines are shown in the Call Frequency section 816. As can be seen calls from the kernel_measureFFT are divided between its two children at rates of FFT_transform_internal—43.71% and FFT_inverse—56.28%.

Those skilled in the art will appreciate that a person may use the visual display 800 to identify bottlenecks in the flow of the computer program being evaluated. For example, the user may examine the Self and Children sections 806, 808 to identify routines that may be using a disproportionate amount of the resources, based on the time spent executing each of the various routines. Further, the Call Frequency sections 814, 816 may identify a particular child routine that is using disproportionate resources based on the percentage call frequency. Armed with information regarding where bottlenecks may exist in the program being evaluated, the user may then alter the flow of the program to more wisely use the resources such that the program being evaluated will now operate more quickly or efficiently.

It should also be noted that while various embodiments may be described in terms of memory storage for graphics processing, it is contemplated that the embodiments described herein may have a wide range of applicability, not just for graphics processes, as would be apparent to one of skill in the art having the benefit of this disclosure.

The particular embodiments disclosed above are illustrative only, as the invention may be modified and practiced in different but equivalent manners apparent to those skilled in the art having the benefit of the teachings herein. Furthermore, no limitations are intended to the details of construction or design as shown herein, other than as described in the claims below. It is therefore evident that the particular embodiments disclosed above may be altered or modified and all such variations are considered within the scope and spirit of the claimed invention.

Accordingly, the protection sought herein is as set forth in the claims below.

What is claimed:

1. A method for evaluating called routines in a computer program, comprising:
periodically interrupting execution of a computer program;
inspecting one or more entries in a call stack to identify one or more possible call operations;
validating the one or more possible call operations as an actual call entry based on the possible call entry being associated with a code segment in a program module; and
collecting data regarding each validated call entry identified during each of the periodic interrupts

2. A method, as set forth in claim 1, wherein inspecting the one or more entries in the call stack to identify one or more possible call operations further comprises identifying each of the one or more call stack entries as a call operation in response to the one or more possible call entries having an address range corresponding to a program module.

3. A method, as set forth in claim 1, further comprising presenting the data to a computer user.

4. A method, as set forth in claim 1, wherein validating the one or more possible call operations as the actual call entry, further comprises validating the one or more possible call operations as the actual call entry based on the possible call operation having an address that does not correspond to a data segment within a program module.

5. A method, as set forth in claim 1, wherein validating the one or more possible call operations as the actual call entry, further comprises validating the one or more possible call operations as the actual call entry based on the possible call operation having an address that correspond to a code segment within a program module.

6. A method, as set forth in claim 1, wherein validating the one or more possible call operations as the actual call entry, further comprises validating the one or more possible call operations as the actual call entry based on the possible call operation having an operational code that corresponds to the actual call entry.

7. A method, as set forth in claim 1, wherein validating the one or more possible call operations as the actual call entry, further comprises validating the one or more possible call operations as the actual call entry based on the possible call operation having an operational code and a length that correspond to the actual call entry.

8. A computer readable storage device encoded with at least one instruction that, when executed by a computer, performs a method for evaluating called routines in a computer program, comprising:
periodically interrupting execution of the computer program;
inspecting one or more entries in a call stack to identify one or more possible call operations;
validating the one or more possible call operations as an actual call entry based on the possible call entry being associated with a code segment in a program module; and;
collecting data regarding each validated call entry identified during each of the periodic interrupts.

9. A computer readable storage device, as set forth in claim 8, wherein inspecting the one or more entries in the call stack to identify one or more possible call operations further comprises identifying each of the one or more call stack entries as a call operation in response to the one or more possible call entries having an address range corresponding to a program module.

10. A computer readable storage device, as set forth in claim 8, further comprising presenting the data to a computer user.

11. A computer readable storage device, as set forth in claim 8, wherein validating the one or more possible call operations as the actual call entry, further comprises validating the one or more possible call operations as the actual call entry based on the possible call operation having an address that does not correspond to a data segment within a program module.

12. A computer readable storage device, as set forth in claim 8, wherein validating the one or more possible call operations as the actual call entry, further comprises validating the one or more possible call operations as the actual call entry based on the possible call operation having an address that correspond to a code segment within a program module.

13. A computer readable storage device, as set forth in claim 8, wherein validating the one or more possible call operations as the actual call entry, further comprises validating the one or more possible call operations as the actual call entry based on the possible call operation having an operational code that corresponds to the actual call entry.

14. A computer readable storage device, as set forth in claim 8, wherein validating the one or more possible call operations as the actual call entry, further comprises validating the one or more possible call operations as the actual call entry based on the possible call operation having an operational code and a length that correspond to the actual call entry.

15. An apparatus for evaluating called routines in a computer program, comprising:
a processing device having a call stack and being adapted to execute the computer program and periodically interrupt execution of the computer program; the processing device being adapted to operate during the periodic interrupt to inspect one or more entries in the call stack to identify one or more possible call operations during the periodic interrupt, to validate the one or more possible call operations as an actual call entry based on the possible call entry being associated with a code segment in a program module, and to collect data regarding each validated call entry.

16. An apparatus, as set forth in claim 15, wherein inspecting the one or more entries in the call stack to identify one or more possible call operations further comprises the processing device identifying each of the one or more call stack entries as a call operation in response to the one or more possible call entries having an address range corresponding to a program module.

17. An apparatus, as set forth in claim 15, further comprising the processing device presenting the data to a computer user

18. An apparatus, as set forth in claim 15, wherein validating the one or more possible call operations as the actual call entry, further comprises the processing device validating the one or more possible call operations as the actual call entry based on the possible call operation having an address that does not correspond to a data segment within a program module.

19. An apparatus, as set forth in claim 15, wherein validating the one or more possible call operations as the actual call entry, further comprises the processing device validating the one or more possible call operations as the actual call entry based on the possible call operation having an address that correspond to a code segment within a program module.

20. An apparatus, as set forth in claim 15, wherein validating the one or more possible call operations as the actual call entry, further comprises the processing device validating the one or more possible call operations as the actual call entry based on the possible call operation having an operational code that corresponds to the actual call entry.

21. An apparatus, as set forth in claim 15, wherein validating the one or more possible call operations as the actual call entry, further comprises the processing device validating the one or more possible call operations as the actual call entry based on the possible call operation having an operational code and a length that correspond to the actual call entry.
